(19) United States
(12) Patent Application Publication
(10) Pub. No.: US 2024/0221311 A1
(43) Pub. Date: Jul. 4, 2024

(54) FOUR-DIMENSIONAL SPATIO-TEMPORAL STRUCTURE AGGREGATION PLATFORM FOR METAVERSE INFORMATION

(71) Applicant: Tongji University, Shanghai (CN)

(72) Inventors: Yunsheng Su, Shanghai (CN); Jinxin Shao, Shanghai (CN); Zhepeng Wang, Shanghai (CN); Yao Lu, Shanghai (CN); Xihan Cheng, Shanghai (CN); Ruoyu Li, Shanghai (CN); Yunxin Yan, Shanghai (CN)

(21) Appl. No.: 18/398,469

(22) Filed: Dec. 28, 2023

(30) Foreign Application Priority Data
Dec. 29, 2022 (CN) 202211726243.4

(51) Int. Cl. G06T 17/05; G06F 3/04815; G06F 16/28; G06F 16/9537; G06T 15/50; G06T 19/20

(52) U.S. Cl. CPC G06T 17/05; G06F 3/04815; G06F 16/283; G06F 16/9537; G06T 15/506; G06T 19/20; G06T 2200/24; G06T 2219/004; G06T 2219/2012

(57) ABSTRACT

The present disclosure discloses a four-dimensional spatio-temporal structure aggregation platform for metaverse information, and relates to the technical field of search engine design. According to the present disclosure, based on original geographic coordinates of the earth, a time axis perpendicular to a ground and pointing to a center of the earth is constructed, and light spots are used for mapping an information website portal, so that an objective of expressing a four-dimensional information spatio-temporal structure by using a three-dimensional space is achieved, thereby improving rationality of information classification while improving an information aggregation degree and search efficiency.

### CROSS REFERENCE TO RELATED APPLICATION

This patent application claims the benefit and priority of Chinese Patent Application No. 202211726243.4, filed with the China National Intellectual Property Administration on Dec. 29, 2022, the disclosure of which is incorporated by reference herein in its entirety as part of the present application.

### TECHNICAL FIELD

The present disclosure relates to the field of search engine design, and in particular, to a four-dimensional spatio-temporal structure aggregation platform for metaverse information.

### BACKGROUND

Baidu, Alibaba and TikTok and other conventional websites may be referred to as planar two-dimensional information classification websites based on their search functions. Google and Baidu generally focus on keyword search, Google Maps, Baidu Maps, and the like achieve map search based on a location, WeChat can implement keyword and time search, and TikTok is usually based on artificial intelligence (AI) topic pushing.

In order to further improve search efficiency, based on the existing two-dimensional information classification websites, a search website for a three-dimensional physical world, such as Google Earth, is also designed. Although the existing search website for the three-dimensional physical world has a time axis, the search website cannot express information at different times.

### SUMMARY

In order to solve the above problems existing in the prior art, the present disclosure provides a four-dimensional spatio-temporal structure aggregation platform for metaverse information, which can realize an objective of expressing a four-dimensional information spatio-temporal structure by using a three-dimensional spatial structure, thereby improving rationality of information classification while improving an information aggregation degree and search efficiency.

To achieve the above objective, the present disclosure provides the following solutions:

A four-dimensional spatio-temporal structure aggregation platform for metaverse information includes:
a time axis construction module configured to construct a time axis based on geographic coordinates of the earth, where the time axis is a time ray perpendicular to the ground with a center of the earth as a starting point;
a spatio-temporal four-dimensional architecture construction module connected to the time axis construction module and configured to fuse the time axis with a digitized earth as a spatial grid and the center of the earth as an origin to obtain a spatio-temporal four-dimensional architecture; and
a light spot mapping module connected to the spatio-temporal four-dimensional architecture construction module, and configured to map a website portal of information to be displayed into light spots and place the light spots on the time axis.

Preferably, the four-dimensional spatio-temporal structure aggregation platform for metaverse information further includes:
a visualization processing module configured to perform visualization processing on the spatio-temporal four-dimensional architecture mapped with light spots based on a set interface to obtain a platform interface.

Preferably, when a user selects any of the light spots, the platform interface displays information corresponding to the light spot.

Preferably, the platform interface includes a main vision of a virtual earth, a time button, a zoom button, and a sidebar.

Preferably, the sidebar includes an account information portal, an item portal, a setting portal, a feedback portal, a help portal, and a search portal.

Preferably, the search portal searches and locates event information based on search content; and the search content includes information time and an information label.

Preferably, a radius of each of the light spots is set based on browsing parameters of the information to be displayed; an information type of the light spot and a label of the light spot are expressed in different colors; and the browsing parameter includes: a search volume, a number of likes, and a number of comments.

Preferably, time circle layers and a spatio-temporal spherical shell are further arranged in the spatio-temporal four-dimensional architecture; and different time circle layers are configured to carry light spots in different time periods.

Preferably, one information type is expressed by one spatio-temporal four-dimensional architecture.

Preferably, a position of the time axis on the digitized earth and a position of the light spot on the time axis change over time.

According to specific embodiments of the present disclosure, the present disclosure has the following technical effects:

In the four-dimensional spatio-temporal structure aggregation platform for metaverse information according to the present disclosure, based on original geographic coordinates of the earth, a time axis perpendicular to a ground and pointing to a center of the earth is constructed, and light spots are used for mapping an information website portal, so that an objective of expressing a four-dimensional information spatio-temporal structure by using a three-dimensional space is achieved, thereby improving rationality of information classification while improving an information aggregation degree and search efficiency.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic structural diagram of a four-dimensional spatio-temporal structure aggregation platform for metaverse information according to the present disclosure;

FIG. 2 is a display example diagram of a startup interface of a four-dimensional spatio-temporal structure aggregation platform for metaverse information according to an embodiment of the present disclosure;

FIG. 3 is a display example diagram of a time axis interface of a four-dimensional spatio-temporal structure aggregation platform for metaverse information according to an embodiment of the present disclosure;

FIG. 4 is an example diagram of an information display page of a four-dimensional spatio-temporal structure aggregation platform for metaverse information according to an embodiment of the present disclosure;

FIG. 5 is a schematic interface display diagram of a visual information layer according to an embodiment of the present disclosure; and

FIG. 6 is a schematic display diagram of a spatio-temporal spherical shell interface according to an embodiment of the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a four-dimensional spatio-temporal structure aggregation platform for metaverse information, which can realize an objective of expressing a four-dimensional information spatio-temporal structure by using a three-dimensional spatial structure, thereby improving rationality of information classification while improving an information aggregation degree and search efficiency.

In order to make the above objective, features and advantages of the present disclosure clearer and more comprehensible, the present disclosure will be further described in detail below in combination with accompanying drawings and specific implementations.

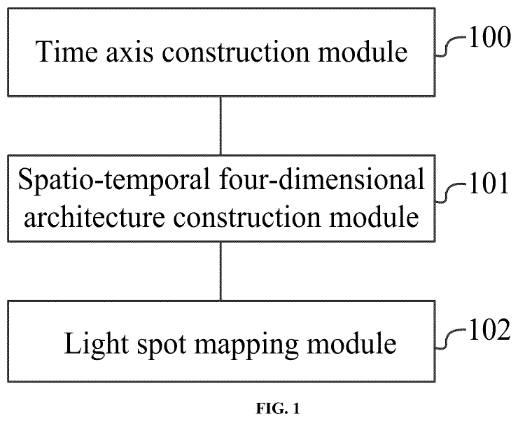

As shown in FIG. 1, a four-dimensional spatio-temporal structure aggregation platform for metaverse information according to the present disclosure includes a time axis construction module 100, a spatio-temporal four-dimensional architecture construction module 101, and a light spot mapping module 102.

The time axis construction module 100 is configured to construct a time axis based on geographic coordinates of the earth. The time axis is a time ray perpendicular to the ground with a center of the earth as a starting point.

The spatio-temporal four-dimensional architecture construction module 101 is connected to the time axis construction module 100. The spatio-temporal four-dimensional architecture construction module 101 is mainly configured to fuse the time axis with a digitized earth as a spatial grid and the center of the earth as an origin to obtain a spatio-temporal four-dimensional architecture. The time range expressed on the time axis may be from the birth of the earth to the future. For example, the closer to the center of the earth means the longer time, the closer to the earth's surface means the closer time, and the farther away from the earth's surface to the universe means the closer to the future. Based on this, a position of the time axis on the digitized earth and a position of the light spot on the time axis change over time.

The light spot mapping module 102 is connected to the spatio-temporal four-dimensional architecture construction module 101. The light spot mapping module 102 is mainly configured to map a website portal of fragmented and unitized information to be displayed into light spots and place the light spots on the time axis, that is, the light spots are placed in coordinates of a corresponding time and space. A radius of each of the light spots may be determined by a search volume, a number of likes, a number of comments, and the like of information. An information type or label of the light spot may be expressed by a color of the light spot. When a user selects a light spot, a website portal represented by the light spot is activated, so that content in a website corresponding to the website portal is displayed to form information interaction.

In order to facilitate information search, time and space labels may be added to each piece of event information, so as to accurately search and locate historical and current events and plan future events. During practical application, some permissions in the future can be opened to the public, so that the public can upload events themselves. Based on this setting, the four-dimensional spatio-temporal structure aggregation platform for metaverse information constructed according to the present disclosure can cover the entire history of human civilization, and all those with time and place, such as cultural relics, songs and masterpieces, can be searched. Individuals may have personal histories, such as photos they have taken and diaries with coordinates (with spatio-temporal attributes).

During use of the above-mentioned spatio-temporal four-dimensional architecture, different information categories are aggregated on different spatio-temporal four-dimensional architectures (also referred to as metaverse spatio-temporal structures), so that different enterprise users can pay attention to and manage the spatio-temporal four-dimensional architectures.

Further, in order to visually display the above-mentioned constructed spatio-temporal four-dimensional architecture, so as to improve information search and display efficiency, the four-dimensional spatio-temporal structure aggregation platform for metaverse information according to the present disclosure may further include a visualization processing module; and the visualization processing module is configured to perform visualization processing on the spatio-temporal four-dimensional architecture mapped with light spots based on a set interface to obtain a platform interface. When the user selects any light spot, the platform interface displays information corresponding to the light spot.

Further, in order to make the expressed information more visual and perfect, time circle layers and a spatio-temporal spherical shell are further arranged in the spatio-temporal four-dimensional architecture; and different time circle layers are configured to carry light spots in different time periods. The time circle layers may be classified based on a time margin. For example, 10 years, 50 years, or the like may be used as one time circle layer. Moreover, different colors or different forms may be used to render different time circle layers.

During actual arrangement, the time axis construction module 100, the spatio-temporal four-dimensional architecture construction module 101, the light spot mapping module 102 and the visualization processing module described above may be all carried in the same processor or computer.

Taking operation of a platform interface obtained by visualization processing according to the present disclosure as an example, functions of a search engine, namely the above-mentioned four-dimensional spatio-temporal structure aggregation platform for metaverse information according to the present disclosure, in a concrete implementation process will be described below. During actual application, this embodiment is only for illustration, and is not used as a specific limitation to the present disclosure.

An overall operation process of the platform interface includes: after logging in from a welcome interface, entering a main interface of the platform, and searching based on a user's own requirements; when searched information is presented on the interface, clicking a “Time button” to expand a “Time axis”, selecting a time point from the time axis from a time dimension, or selecting a light spot from a space dimension, popping up a “Works pop-up panel” of the event information, so as to understand key information, and continuing to click to view details.

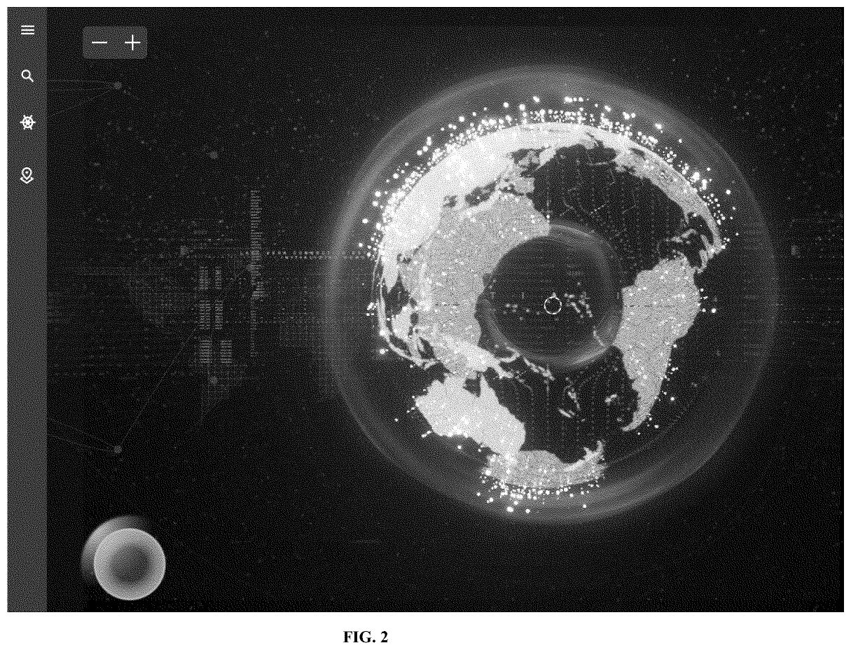

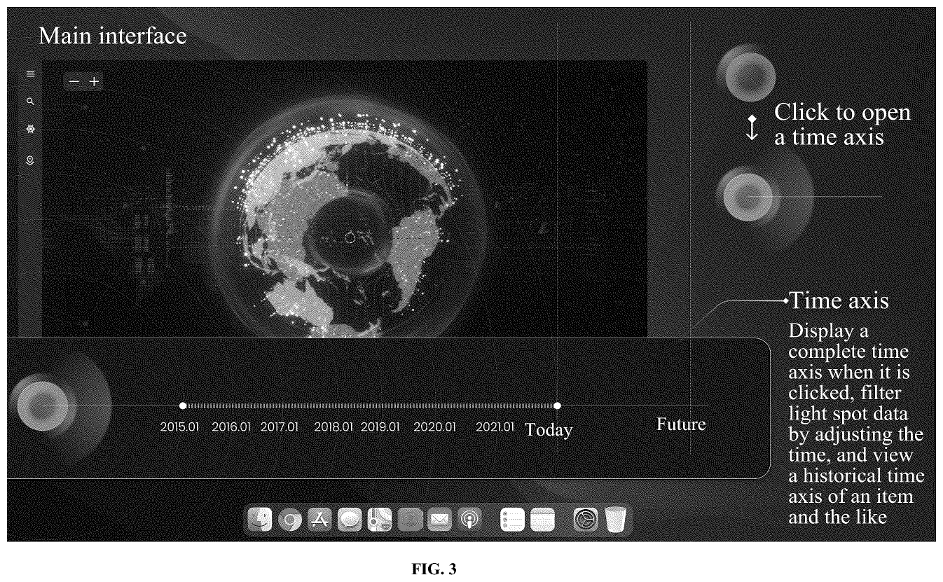

After registration and logging in to an account, the main interface of the platform may be entered, as shown in FIG. 2. As shown in FIG. 3, the main interface of the platform in this embodiment may include a main vision of a virtual earth, a time button, a zoom button, and a sidebar. The virtual earth can be manually zoomed in or out by clicking “+” or “−”.

The sidebar includes an account information portal, an explorer portal, an item portal, a setting portal, a feedback portal, a help portal, and a search portal, but is not limited thereto. Functions of the portals may be set based on actual operation requirements. During use of the search portal, searching may be performed by means of a category, a keyword, and a title. The explorer portal allows the user to explore an item at random. The item portal may include collected items in the four-dimensional spatio-temporal structure aggregation platform for metaverse information.

A complete time axis is displayed by default. Light spots are filtered by adjusting search time, and a historical time axis of an item may be viewed. After the user inputs searched content, the time axis and the virtual earth display light spots and time of the searched information contained in a searched category. The time axis can be expanded by clicking the time button, as shown in FIG. 3.

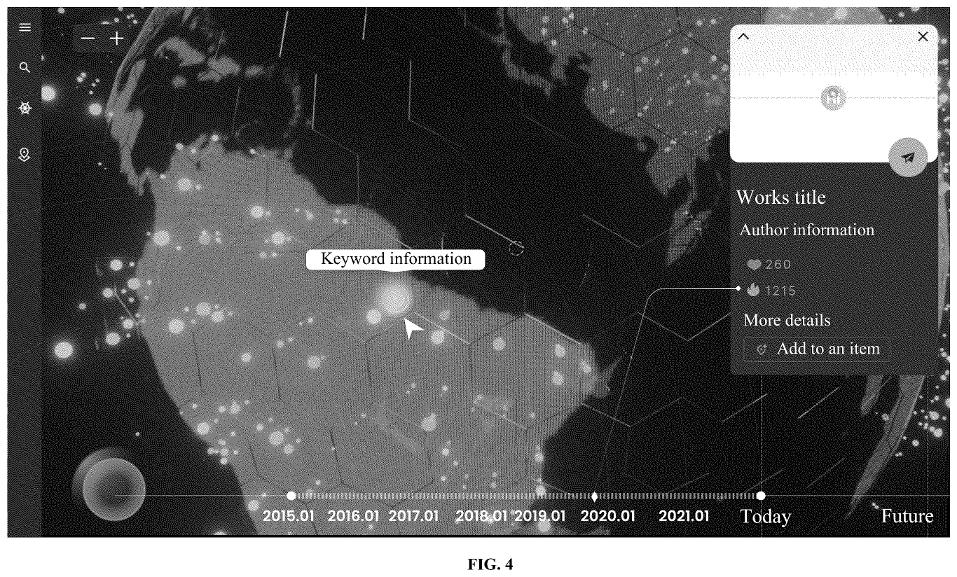

As shown in FIG. 4, the spatio-temporal four-dimensional architecture (the virtual earth including light spots and a time axis) is zoomed in, a light spot is selected from the virtual earth (the time of the light spot corresponds to a time point on the time axis), and when a mouse stays at the light spot, a keyword and an item label of the information are displayed. After clicking, the “Works pop-up panel” of this event pops up, and an information preview page is displayed. A number of likes, popularity, and the like of this information can be seen from the preview page, and units specifically included are “Works preview”, “Works title”, “Share an item”, “Author”, “Instructor”, “Number of likes”, “Popularity value”, “Learn details”, “Add to an item”, and the like. The item may be shared to others by clicking “Share an item”. A works details page may pop up by clicking “Learn details”. The item is added to the user's favorite items by clicking “Add to an item”.

The works details page that pops up after “Learn details” is clicked may contain the following information: “Works title”, “Author”, “Instructor”, “Works video”, “Works pictures”, and the like. A like may be given to the works by clicking a “Heart-shaped icon”. A popularity value of the works may be increased by clicking a “flame icon”. The item may be shared to others via this platform or other platforms (WeChat, QQ, and the like) by clicking “Share an item”. A pop-up is closed by clicking “x”.

Interfaces in FIGS. 2-4 are only used as examples, and text information which is partially blurred or not displayed therein is not used as a specific limitation to the present disclosure.

Based on the above description, the spatio-temporal search engine (namely, the four-dimensional spatio-temporal structure aggregation platform for metaverse information) according to the present disclosure includes the following key elements:
Spatio-temporal earth: A canvas carrying information.
Search box: A port for information search.
Light spot: An information carrier, an interactive point that can be zoomed in, representing an information element.
Spatio-temporal set: Several information elements, representing a type of related information.
Connection line: A connection line between light spots, representing a relationship between information.
Time axis: Configured to filter and present information to information elements with different time distributions.
Spatio-temporal slice: A way to view specific information.

Furthermore, these elements can present the following information in this spatio-temporal search engine:

### 1. Light Spot:

A radius of a peripheral halo of the light spot represents a number of viewers.

A radius of a halo in a middle layer of the light spot represents popularity calculated through a combination of a number of views, forwarding, and likes.

A radius of a halo in an inner layer of the light spot represents a forwarding amount.

Colors of different light spots represent different topics. For example, red represents design works that are biased toward a spatial design, green represents design works that are biased toward an interactive design, and blue represents design works that are biased toward a product design.

Therefore, a more important historical event indicates a larger light spot and easier noting. A light spot form of a key event in the future may be more obvious and beautiful, such as a mushroom cloud in an explosive form, or even finally become crystalline crystals.

### 2. Time Axis:

A distance between the light spot and an origin of the earth represents the time axis. Being from near to far away from the origin of the earth represents the time: the past, present, and future. As time goes by, the time axis and the position of the light spot are also moving.

### 3. Spatio-Temporal Earth:

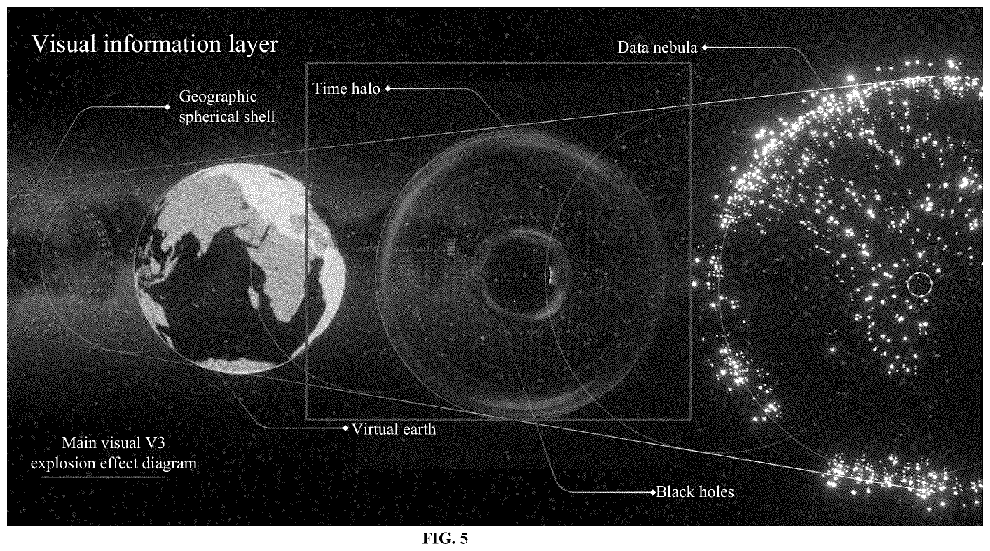

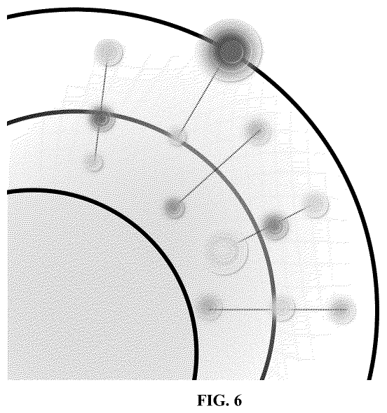

The surface of the spatio-temporal earth is divided into an upper surface and a lower surface. The lower surface has a height that is a search start time of the search time axis, and is referred to as an “initial surface”. The upper surface has a height that is a search end time (that is, the distance from the earth at the search end time) of the search time, and is referred to as an “end surface”. The two surfaces form a “spatio-temporal spherical shell” with a thickness on the interface, like a nebula layer, representing the search result range during this period of time, as shown in FIGS. 5 and 6.

A “space-time line” is emitted from a location of a light spot to the center of the earth as a time coordinate axis, and light spots generated at different times in the same location are arranged on the time axis based on the scale of the time axis (for example, the unit is days).

### 4. Spatio-Temporal Slice:

The spatio-temporal slice depends on the time axis, and is the concretization of details of information elements on the time axis.

The spatio-temporal slice is configured to show detailed information of one or more light spots presented on the earth at the same time.

The detailed information is displayed on the spatio-temporal slice and also on the time axis, forming an “event collection”.

The spatio-temporal slice is presented at the same time as a three-dimensional spatio-temporal earth, showing two-dimensional information and three-dimensional information on the same screen.

The spatio-temporal slice can show the past, present and future.

In visual presentation, visual information may fall into several levels: a geographic spherical shell, a virtual earth, a time halo (including black holes), and data nebula.

In this embodiment, the collected and entered works information may include four parts: “basic information”, “author information”, “evaluation information”, and “display information”.

Embodiments of this description are described in a progressive manner, each embodiment focuses on the difference from other embodiments, and for the same and similar parts between the embodiments, reference may be made to each other.

Specific examples are used herein for illustration of principles and implementations of the present disclosure. The descriptions of the above embodiments are merely used for assisting in understanding the method of the present disclosure and its core ideas. In addition, those of ordinary skill in the art can make various changes in terms of specific implementations and the scope of application in accordance with the ideas of the present disclosure. In conclusion, the content of this description shall not be construed as limitations to the present disclosure.

What is claimed is:

1. A four-dimensional spatio-temporal structure aggregation platform for metaverse information, comprising:
a time axis construction module configured to construct a time axis based on geographic coordinates of the earth, wherein the time axis is a time ray perpendicular to the ground with a center of the earth as a starting point;
a spatio-temporal four-dimensional architecture construction module connected to the time axis construction module and configured to fuse the time axis with a digitized earth as a spatial grid and the center of the earth as an origin to obtain a spatio-temporal four-dimensional architecture; and
a light spot mapping module connected to the spatio-temporal four-dimensional architecture construction module, and configured to map a website portal of information to be displayed into light spots and place the light spots on the time axis.

2. The four-dimensional spatio-temporal structure aggregation platform for metaverse information according to claim 1, further comprising:
a visualization processing module configured to perform visualization processing on the spatio-temporal four-dimensional architecture mapped with light spots based on a set interface to obtain a platform interface.

3. The four-dimensional spatio-temporal structure aggregation platform for metaverse information according to claim 2, wherein when a user selects any of the light spots, the platform interface displays information corresponding to the light spot.

4. The four-dimensional spatio-temporal structure aggregation platform for metaverse information according to claim 2, wherein the platform interface comprises a main vision of a virtual earth, a time button, a zoom button, and a sidebar.

5. The four-dimensional spatio-temporal structure aggregation platform for metaverse information according to claim 4, wherein the sidebar comprises an account information portal, an item portal, a setting portal, a feedback portal, a help portal, and a search portal.

6. The four-dimensional spatio-temporal structure aggregation platform for metaverse information according to claim 5, wherein the search portal searches and locates event information based on search content; and the search content comprises information time and an information label.

7. The four-dimensional spatio-temporal structure aggregation platform for metaverse information according to claim 1, wherein a radius of each of the light spots is set based on browsing parameters of the information to be displayed; an information type of the light spot and a label of the light spot are expressed in different colors; and the browsing parameter comprises: a search volume, a number of likes, and a number of comments.

8. The four-dimensional spatio-temporal structure aggregation platform for metaverse information according to claim 7, wherein time circle layers and a spatio-temporal spherical shell are further arranged in the spatio-temporal four-dimensional architecture; and different time circle layers are configured to carry light spots in different time periods.

9. The four-dimensional spatio-temporal structure aggregation platform for metaverse information according to claim 1, wherein one information type is expressed by one spatio-temporal four-dimensional architecture.

10. The four-dimensional spatio-temporal structure aggregation platform for metaverse information according to claim 1, wherein a position of the time axis on the digitized earth and a position of the light spot on the time axis change over time.
